(19) United States
(12) Patent Application Publication
(10) Pub. No.: US 2009/0146438 A1
(43) Pub. Date: Jun. 11, 2009

(54) Gate Latch Mechanism

(76) Inventors: JEAN VIAUD, GRAY (FR); EMMANUEL CHAPON, VELET (FR)

Correspondence Address: DEERE & COMPANY, ONE JOHN DEERE PLACE, MOLINE, IL, 61265, US

(21) Appl. No.: 12/329,799

(22) Filed: Dec. 8, 2008

(30) Foreign Application Priority Data
Dec. 11, 2007 (EP) 07122926.4

(51) Int. Cl. E05C 19/00

(52) U.S. Cl. 292/300

(57) ABSTRACT

A gate latch mechanism is provided on a round baler to pull a gate into a closed position and to lock it during baling operation. Bearings of an actuator on the gate and on the latch are located such that during the closing movement of the gate by means of the actuator, said actuator experiences a movement away from the bearing of the gate thereby allowing a locking pin to move over the latch and to overcome an early interference with the latter.

### FIELD OF THE INVENTION

This invention relates to a gate latch mechanism between a gate carrier having a latch, and a gate having a locking pin and being journalled about a bearing on the gate carrier by means of an actuator.

### BACKGROUND OF THE INVENTION

DE 40 12 755 C1 discloses a round baler where a gate is pivoting about a horizontal axis on the chassis of the round baler between a closed and an open position, whereas this axis is located on the top front area of the gate. On the chassis of the round baler is also provided a latch with a recess, in which a locking pin on the gate may be received and captured until said latch is moved vertically towards an open position. The gate moves into its closed position based on its own weight. During this movement the gate is supported by a hydraulic cylinder resting on and thereby depressing the latch. Once the gate has reached the closed position the hydraulic cylinder retracts and moves the latch upwardly to hold the locking pin. Another example of such a baler is Deutz Fahr round baler RB 4.4.

In another type of a round baler the gate is journalled about an axis substantially in the center of a bale chamber, see for example EP 1308079 A1 or Vermeer round baler 504 HE. In this case the weight of the gate is not sufficient to overcome the tension in the belts, friction in the bearings, obstructions by crop etc. to safely reach the closed position, where it can be locked. Here a more complicated locking mechanism is necessary to securely move and hold the locking pin in the closed position.

### SUMMARY OF THE INVENTION

In view of the foregoing it can be seen that there is a need to provide a gate latch mechanism, which is simple and reliable and does not obstruct the path of the locking pin moving towards the locking position.

By means of this teaching the actuator, like a hydraulic, electric or pneumatic motor, may pull the gate down and at the same time raise the latch without obstructing the path of the locking pin. Due to a tilting movement of the actuator about its bearings during the closing movement of the gate an additional linear movement is created, which moves the latch down to clear the way for the locking pin. This additional linear movement compensates for the contraction of the actuator. Obviously the given equation allows multiple adjustments of the location of the actuator and the latch to the weight of the gate, the speed to move it up and down, the force needed to close it and keep it closed, etc.

Under circumstances with little forces breaking the downward movement of the gate, it might be sufficient to use one actuator on one side of the baler to raise and one to lower the gate on the other side. However, when stronger forces apply having two single acting actuators working in different directions on each side of the baler, would be better, since this would avoid bending and torsion forces. The safest and least space consuming solution however would be the use of one double acting actuator per side.

Using a curved profile on the receiving contour will allow the locking pin to slide over it and/or provide clearance such that no undue friction or interference happens between the pin and the latch. The curve may be of any form, which follows the movement of the locking pin. This does not exclude, that in one extreme the profile is flat and straight—it is just helpful if the profile corresponds with the path of the locking pin.

A protrusion in the receiving surface of the latch may help to better catch and release the locking pin at the beginning and end of its way over the receiving contour.

### BRIEF DESCRIPTION OF THE DRAWINGS

An embodiment of the invention is described in more detail below with reference to the accompanying drawings wherein:

FIG. 1 is a schematic side view of a round baler with a gate latching mechanism according to the invention;

FIG. 2 illustrates the gate latching mechanism in a position, in which it receives a locking pin;

FIG. 3 illustrates the gate latching mechanism in a position, in which the locking pin slides on a receiving contour; and,

FIG. 4 illustrates the gate latching mechanism in a position, in which the locking pin enters into a locking position.

### DESCRIPTION OF THE PREFERRED EMBODIMENT

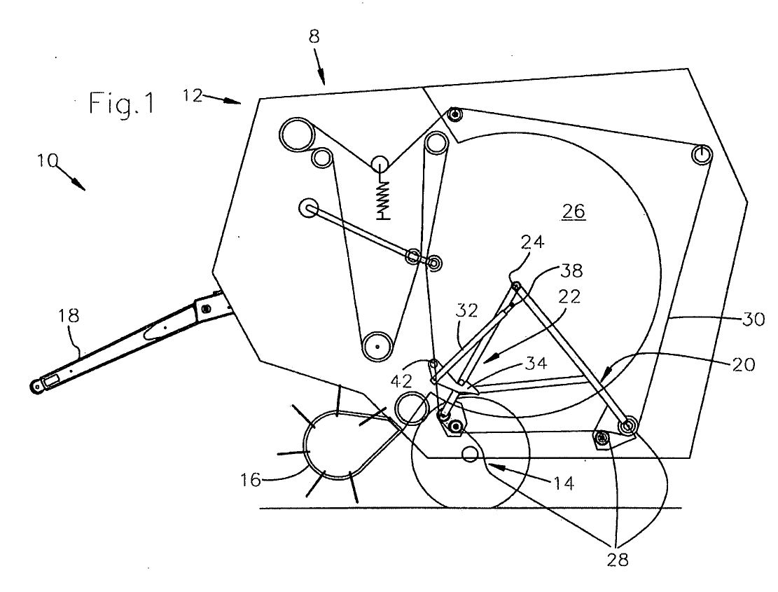

With reference now to the drawings it will be seen that FIG. 1 shows a round baler 10 having a frame 12, wheels 14, a pick-up 16, a tongue 18, a gate 20, and a gate latching mechanism 22.

The round baler 10 is completely described in EP 1308079 A1, which description is incorporated by reference hereby.

The frame 12 contains a front gate carrier 8, that is fixed in its position, and that carries the gate 20, which can move vertically between a closed and an open position to form or release a bale. The gate carrier 8 is composed of side walls, struts, rolls etc. forming a substantially stiff unit in the front area of the frame 12. The movement of the gate 20 happens about a bearing 24, which is located substantially in the center area of a bale chamber 26, although this exact location may vary.

The wheels 14 serve to support the frame 12 on the ground, whereas the tongue 18 is used to connect the round baler 10 to a tractor or the like, not shown.

The pick-up 16 collects crop lying on the ground and delivers it rearward into the bale chamber 26, where a bale is formed therefrom.

The gate 20 is of the so-called light gate type, which means it contains only rolls 28 and baling means 30 in the form of belts trained over the rolls 28 to form the bale chamber 26. However, the gate 20 does not include sidewalls, since they are part of the frame 12. Again, this light gate type is advantageous when using the invention, but not necessary. In FIG. 1 the gate 20 assumes its lower and closed position, i.e. in which the bale chamber 26 is closed.

The gate latching mechanism 22 contains an actuator 32, a latch 34 and a locking pin 36 and is provided at least on one side of the round baler 10 outside the bale chamber 26.

The actuator 32 is formed as a double acting hydraulic motor with a piston moving longitudinally in either direction. At its upper end area the actuator 32 is journalled on the gate 20 by way of a bearing 38 and in a lower end area by way of a bearing 40 on the latch 34.

The latch 34 is of an elongated form, which has a bearing 42 at one end, namely facing the gate carrier 8, a receiving contour 44 at the opposite end and on the upper side, a hook portion 46 between the bearing 42 and the receiving contour 44, being open upwardly, and the bearing 40 between the receiving contour 44 and the bearing 42. In this case the bearing 42 is located between the hook portion 46 and the bearing 42. The bearing 42 is fixed on the gate carrier 8 and is formed by a pin, shaft or the like and a hole, which each may be on the gate carrier 8 or on the latch. The receiving contour 44 extends over about ⅖ of the latch 34 and is slightly bent upward to form a convex curve. The hook portion 46 is formed by a step 48 at the end of the receiving contour 44 facing the bearing 42, whereas said step 48 is sized and shaped such, that it can securely hold the locking pin 36 in its locked position. In the area of the bearing 40 the latch 34 is slightly higher than in its remainder to provide sufficient space and strength to receive the bearing 40, which again is formed as a pin and a hole. Both bearings 40, 42 are oriented in the same direction. The latch 34 may be formed as a single piece or as an assembly of two parallel pieces of sheet metal connected to each other. The area, where the hook portion is located is the smallest and gives some flexibility to the latch 34.

The locking pin 36 is formed by a rigid pin or rotating roll or the like on such pin, provided on the gate 20 at a position, which moves the locking pin 36 along the receiving contour 44 and into the hook portion 46 when the gate 20 closes the bale chamber 26.

Starting from this description various momentum arms are generated, namely:

a) a moment arm L2 extending from the bearing 24 of the gate 20 perpendicular to the longitudinal axis of the actuator 32;

b) a moment arm L3 extending from the bearing 24 of the gate 20 to and perpendicular onto a line perpendicular on the receiving contour 44, where it is contacted by the locking pin 36;

c) a moment arm L1 extending from the bearing 42 of the latch 34 perpendicular to the longitudinal axis of the actuator 32;

d) a moment arm L4 extending from the bearing 42 of the latch 34 to and perpendicular onto the line perpendicular on the receiving contour 44, where it is contacted by the locking pin 36;

In order to achieve a movement of the locking pin 36 over the receiving contour 44 into the hook portion 46, the relationship of L2/L3 divided by L1/L4 should be bigger than 1.5.

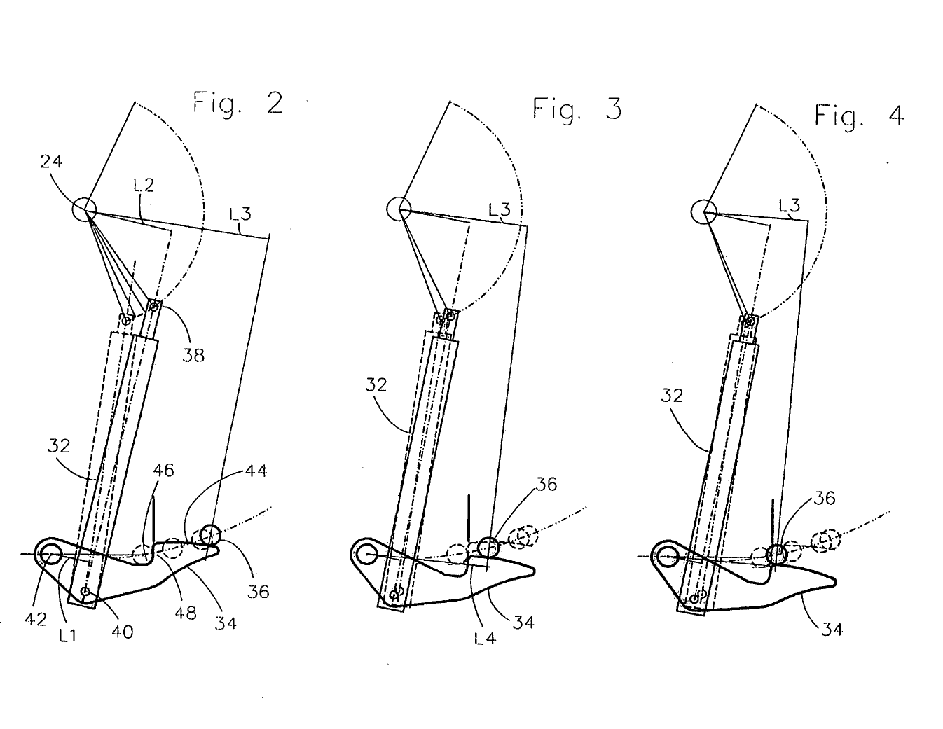

It can be seen in FIGS. 2 through 4, that during the closing movement of the gate 20:
actuator 32 retracts actively and thereby pulls the latch 34 up and the gate 20 down;
actuator 32 tilts about the bearing 40 towards the gate carrier 8 and the gate pin 36 pushes down the latch 34 thereby, whereas the contact pressure of the pin 36 is kept minimal by the simultaneous downward movement of the actuator 32 due to its connection with the gate 20;
latch 34 moves down and the locking pin 36 slides against and on the latch 34 until it falls into the notch;

In other words a triangle, the corners of which are defined by bearings 24, 38 and 40, gets flatter and longer during the closing movement of the gate 20, thereby pushing the latch 34 down an amount, which corresponds to the radial path of the moving locking pin 36 with respect to the stationary latch 34.

Finally FIG. 4 shows, in dashed lines, the latch 34 in its raised position, in which the locking pin 36 is captured.

Having described the preferred embodiment, it will become apparent that various modifications can be made without departing from the scope of the invention as defined in the accompanying claims.

The invention claimed is:

1. A gate latching mechanism between a gate carrier having a latch and a gate, the gate having a locking pin and being journalled about a first bearing on the gate carrier by means of an actuator wherein:
the latch is journalled at a first side of the gate carrier about a second bearing and is provided at a second side with a receiving contour for the locking pin;
the actuator is journalled at a first end on the gate and at a second end on the latch between the second bearing and the receiving contour;
a first moment arm (L2) extends from the first bearing of the gate perpendicular to a longitudinal axis of the actuator;
a second moment arm (L3) extends from the first bearing of the gate to and perpendicular onto a line perpendicular on the receiving contour, where it is contacted by the locking pin;
a third moment arm (L1) extends from the second bearing of the latch perpendicular to the longitudinal axis of the actuator;
a fourth momentum arm (L4) extends from the second bearing of the latch to and perpendicular onto the line perpendicular on the receiving contour, where it is contacted by the locking pin; and,
L2/L3 divided by L1/L4>1.5.

2. A gate latch mechanism according to claim 1, wherein the gate is pulled into its locked position by one of: two single acting actuators which can be activated in opposite directions and one double acting actuator.

3. A gate latch mechanism according to claim 1, wherein the receiving contour has a curved profile.

4. A gate latch mechanism according to claim 1 wherein the receiving contour protrudes towards the first bearing of the gate.
